(19) United States
(12) Patent Application Publication
(10) Pub. No.: US 2023/0200603 A1
(43) Pub. Date: Jun. 29, 2023

(54) Crematory Tool

(71) Applicant: Mark Herman, Fremont, OH (US)

(72) Inventor: Mark Herman, Fremont, OH (US)

(21) Appl. No.: 18/083,879

(22) Filed: Dec. 19, 2022

Related U.S. Application Data
(60) Provisional application No. 63/293,228, filed on Dec. 23, 2021.

(51) Int. Cl. A47L 9/04; F23J 1/04

(52) U.S. Cl. CPC A47L 9/04; F23J 1/04; F23G 1/00

(57) ABSTRACT

A blower type tool is designed to be connected to a fluid compressor to provide a stream of fluid that will extract cremains from a crematory, cremation chamber. The tool includes a conduit connected to fluid distribution unit with nozzles to blow fluid against the crematory floor and corners. The nozzles are directed such that the cremains are moved toward and out of the crematory opening. All components of the tool are metal to withstand extreme heat.

### REFERENCE TO RELATED APPLICATION

This application claims priority from U.S. Provisional Application Ser. No. 63/293,228, filed Dec. 23, 2021, the disclosures of which are hereby incorporated by reference.

### FIELD OF THE INVENTION

The present invention generally relates to crematory tools and more particularly to crematory clean out tools.

### BACKGROUND OF THE INVENTION

Cremation is a method of final disposition of a deceased body through combustion. The remains after the cremation process are known as “cremains” which include bone fragments and powdery ash. Cremations take place in a crematory furnace capable of generating temperatures of up to 2,000° F. In a typical process, after the incineration is completed, the remaining fragments and ash are swept out of the crematory. The cremated remains are pulverized, reducing all cremains to powder and small fragments which are then returned to the next of kin in different manners according to custom and country.

The cremation incineration process may take several hours. For efficient use of the crematory, it is desirable to remove the cremains as soon as feasibly possible, when the temperature permits. In doing so, heat energy is preserved and prepares the crematory for the next use. Typically, a large broom type tool is used to sweep out the cremains. Due to the extreme temperatures in the crematory immediately after the process, metal brooms are required to withstand the heat. Of course, the use of brooms is inefficient and ineffective in gathering the finer cremains, leaving cremains behind and leading to co-mingling of cremains from case to case. This should be considered unprofessional and unethical by a certified operator and would be very distressful to all families and general public.

Alternative methods have been proposed to gather cremains after the cremation process. Vacuum type devices have been used. Major drawbacks of vacuum devices are that they are rated to be used in maximum temperatures of up to 900 degrees. Furthermore, being a vacuum, there is a air filtration system that would entrap cremains. An amount of cremains would still be lost in the process.

One solution for gathering of cremains is to wait an extended period of time, up to 24 hours, until the crematory cools. This would effectively shut down the crematory for a day and could allow a more though sweeping or use of a vacuum device without damaging the device. Unfortunately, waiting doesn't guarantee better results of collecting the maximum amount of cremain and allowing the crematory to sit idly while allowing an extensive cool down period is not an efficient use of the crematory.

There is a need for a more efficient device and method of removing cremains from a crematory soon after a cremation process is complete.

### SUMMARY OF THE INVENTION

The present invention is a tool designed for use in removing cremains from a crematory. The tool is designed to be connected to a fluid compressor to provide stream of fluid that will work to extract cremains from the cremator. The tool includes a fluid conduit top connect the air compressor to a nozzle which preferably is directed downwardly and outwardly toward the crematory opening such the cremains are moved toward the opening. Additional nozzles may be directed laterally to move trapped cremains that lie in the corner of the floor and walls. The tool may include a metal brush and hood to deflect the escape of blown cremains. The fluid conduit may include dual ports to a slit type nozzle. The tool weight is carried on an axle with metal wheels for easy operator handling and control. Preferably, all components of the tool are metal to withstand extreme heat.

### BRIEF DESCRIPTION OF THE DRAWINGS

FIG. 1 is a perspective view of a typical cremation chamber.

FIG. 2 is a cross-sectional view of a typical crematory floor and side walls as viewed from the crematory door opening.

FIG. 3 is a perspective view of the tool of the present invention.

FIG. 4 is an enlarged perspective view of the downstream end portion of the tool of FIG. 3 with the cover member removed.

FIG. 5 is an exploded view of the downstream end portion of the tool of FIG. 3.

FIG. 6 is an enlarged side view of a portion of the downstream end portion of FIG. 3.

FIG. 7 is a cut away view of the downstream end portion of the tool of FIG. 3.

FIG. 8 is a bottom view of an alternative fluid distribution unit.

### DESCRIPTION OF PREFERRED EMBODIMENTS

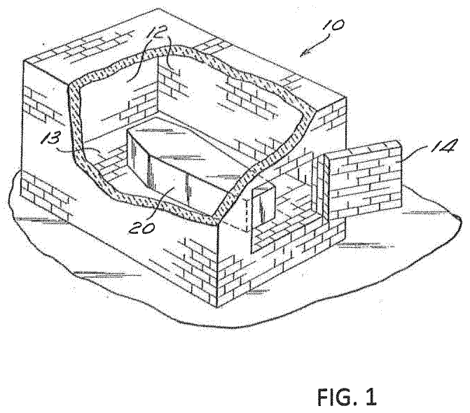

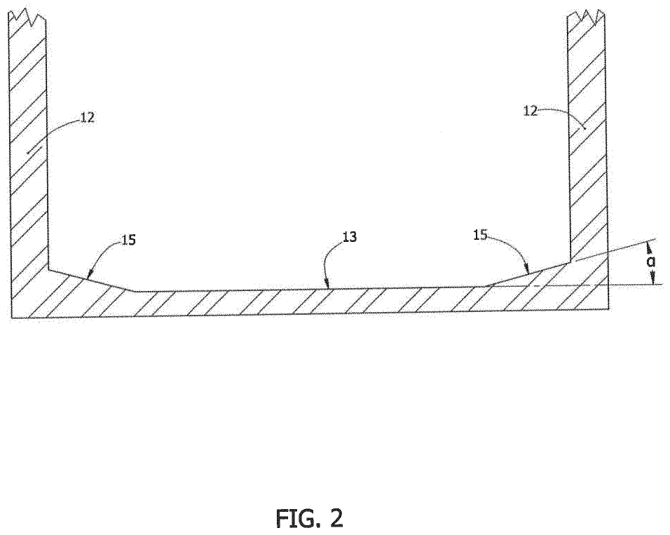

Referring to FIGS. 1 and 2, a crematory 10 is an enclosed furnace having insulated walls 12 and a floor 13. A casket, or cremation container, 20 is positioned in the crematory through an insulated crematory door 14. The floor has a relatively flat center portion 13 and sloped edge portions 15. The floor edges 15 are typically about 6 inches wide and are sloped at an angle “a” of approximately 5-10 degrees in a typical crematory to guide cremains away from the side walls 12.

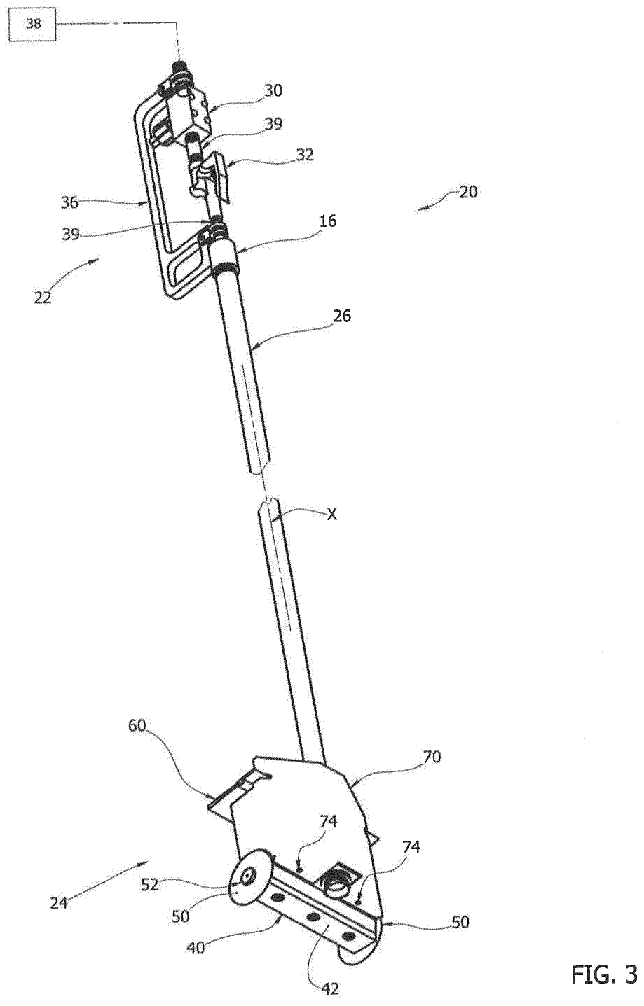

Referring to FIG. 3, a tool 20 adapted for crematory cleaning has an upstream end portion 22 and a downstream end portion 24. A fluid conduit in the form of a stainless steel tube 26 extends between the upstream and downstream end portions. The tube has a longitudinal axis “X” and an inside diameter of ¼ inch, but various other sizes may be used. The tool is at least 8 feet long, and preferably 10 feet long, for easy use in a typical crematory.

The upstream end portion 22 includes an adjustable fluid flow regulator 30 and an on-off trigger 32. Alternatively, the trigger may be a variable flow type, but it is preferred that the flow regulator 30 be adjusted properly so that an on-off trigger can be used. A handle 36 secures and protects the connections between the fluid conduit 26 to the flow regulator 30 and trigger 32, while allowing the operator full control of the tool and allowing the tool to be placed on the floor for cooling without damaging the components of the device. The flow regulator 30, trigger 32 and tube 26 are adapted for fluid communication with a fluid compressor 38 through suitable fittings 39 as is well known in the art. A preferred compressor 38 will provide compressed ambient air at 40-60 psi, but various other capacities may be utilized if properly matched with the tube size, inlet valve etc.

The downstream end portion 24 includes a fluid distribution unit 40 including an air knife 42, through dual sided fluid supply via portions 80, 82 and 84, and to nozzle ports in fasteners 52. Metal wheels 50 are rotatably attached to the air knife with metal fasteners 52 which are threaded into the air knife. A sweep member 60 is attached to the tube between the air knife 40 and the upstream end portion 22. A metal cover 70 extends over the tube 26 from the air knife 40 to the sweep member 60, covering dual sided fluid supply lines.

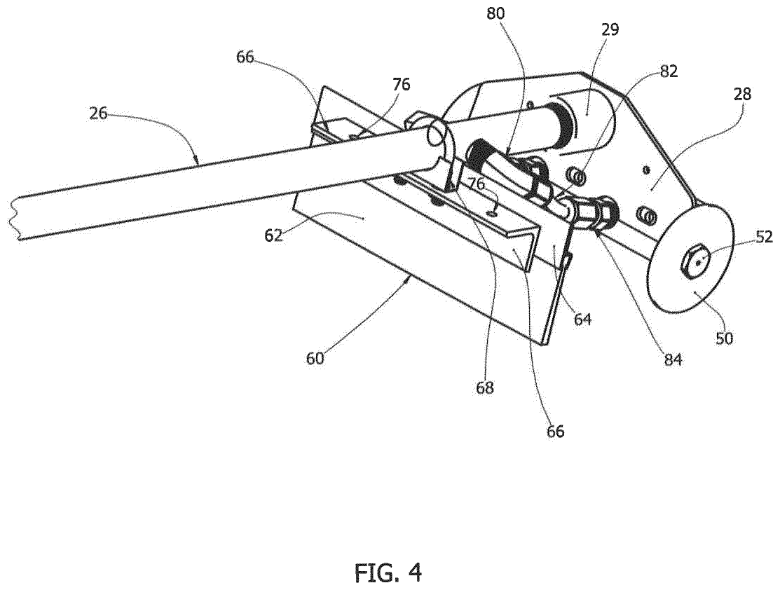

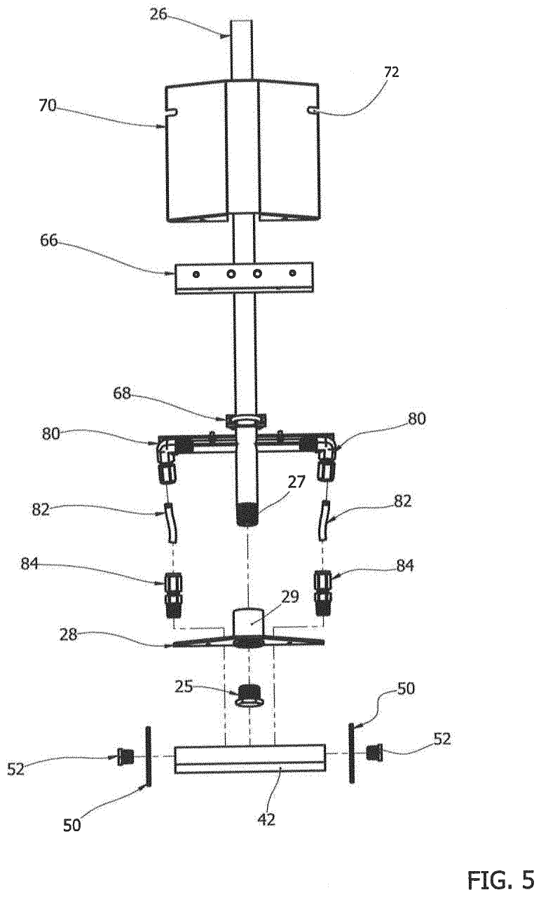

Referring to FIGS. 4, 5, 6 and 7, a custom bracket 28 has a flat plate portion and an internally threaded boss 29 and two threaded holes 74. The tube 26 has a threaded end 27 which is securely threaded into one end of the boss 29. A fastener 25 is threaded into the opposite end of the boss 29 to secure the tube 26 to the bracket 28.

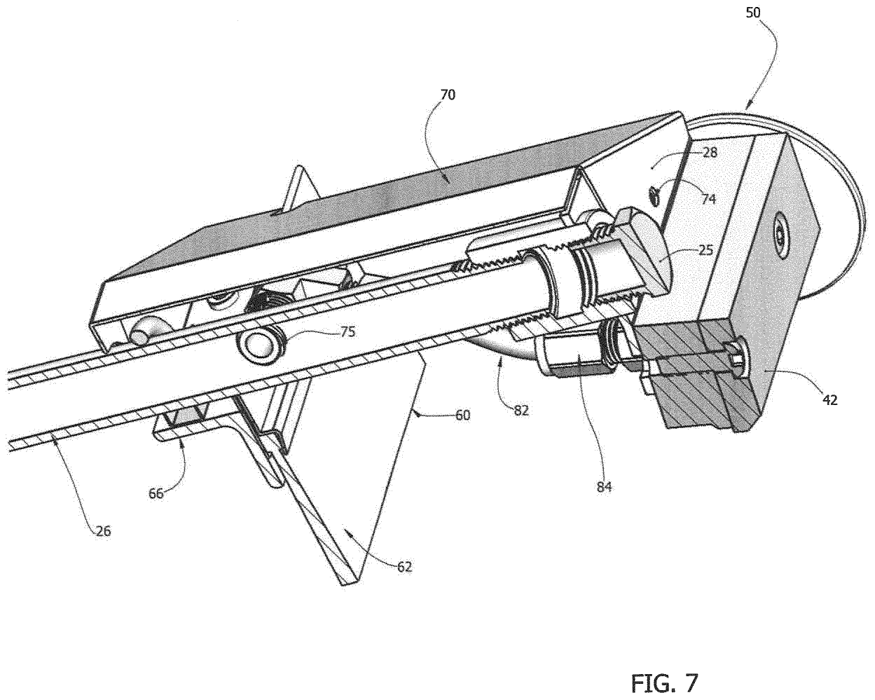

In a preferred embodiment, the fluid conduit includes a dual path from the tube 26 to the air knife 42 through a series of fittings and secondary tubes. Fittings 80 are threaded into ports 75 in the tube 26 (FIG. 7). Fittings 84 are threaded into the air knife 42 and are connected to the fittings 80 through secondary tubes 82. Of course, various other methods and designs may be utilized to provide fluid communication between tube 26 sand the air knife 42.

The metal sweep member 60 includes a wall of flexible metal bristles 62 attached to and extending downward from a holder 64 in which the bristles are clamped. The bristle holder 64 is secured to a bracket 66 by welding or other means. The bracket 66 is clamped to the tube 26 with a vibration damping clamp 68.

Metal cover 70 extends over the tube 26 from the air knife 40 to the sweep member 60. The cover includes notches 72 which fit over the sweep member bristle holder 64. The cover is held in place by 4 screws 8-32 in size, at least 5/16″ long. Two of those screws are threaded into threaded holes in the plate 28 that holds the air knife. The other two screws pass through holes 76 in the angle 66 that holds the brush 60, and are threaded into cinch fasteners (PEM Inserts) in the angle. That combination of 4 bolts will securely hold the hood in place, but allow for its removal for cleaning and maintenance as required.

The cover 70 extends below the axis of rotation of the wheels 50 but does not extend below the wheels. In preferred embedment, the wheels have a diameter of approximately 2 inches. By design, when the tool is held so axis X is parallel to the crematory floor, the cover 70 rides with a gap above the crematory floor of ¼ to 1 inch, preferably about 0.8 inches. The cover 70 and sweep member 60 prevent particles from being blown around uncontrollably.

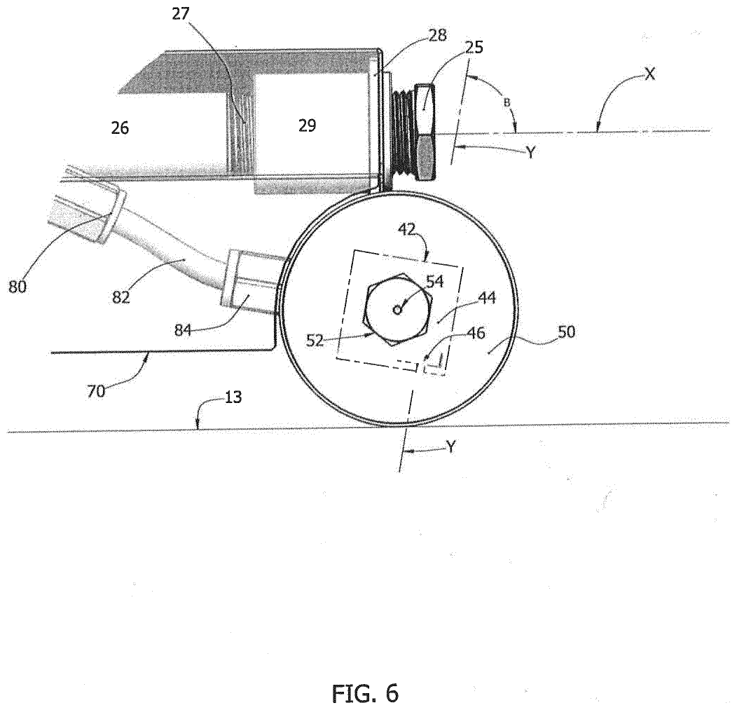

Referring to FIG. 6, the fluid distribution unit 24, in the form of an air knife 42, includes a fluid plenum 44 and a nozzle 46 in the form of a slit which provides a uniform sheet of fluid. The slit extends the full length of the air knife, about 6 inches in a preferred embodiment to match the 6 inch width of typical crematory floor edges 13. A preferred slit width is around 0.002 inches, but the width may be changed, such as by using shims.

Air knives of this type are available from EXAIR Corporation, for example. The air knife 42 is oriented such that the nozzle opening direction “Y” is at an angle “B” to the tube axis X. For example, in a preferred embodiment, an orientation to provide a nozzle angle of 10 degrees relative to a floor 13 would result in an angle of 80 degrees relative to the tube axis X. Nozzle angles of 45 to 90 degrees may be preferred for use in various applications. Nozzle angles of 70 to 89 degrees relative to the tube axis X are generally preferred for crematory use, for example 79 or 80 degrees. Alternatively, the slit nozzle may be replaced by a series of individual jet nozzles (not show) in communication with a plenum and aligned similarly to the air knife slit.

In addition to the downwardly opening nozzle 46, the wheel fasteners 52 include center ports 54 which are in fluid communication with the plenum 44 and serve as nozzles directed outwardly from the air knife at a 90 degree angle from the tube axis X and parallel to the length of the slit 46. The wheel fastener nozzles may be formed with drill holes, around 5/64 inches in diameter in a preferred embodiment.

As noted, it is preferred that all components of the device are heat resistant metal, such as stainless steel.

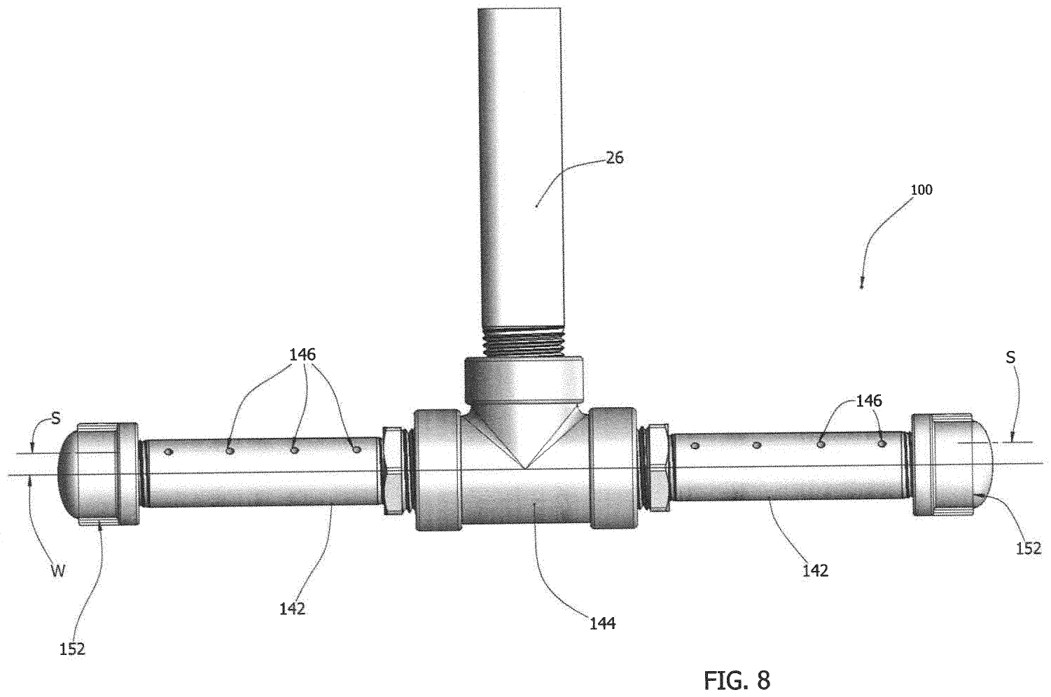

FIG. 8 shows an alternative fluid distribution unit 100 secured to the fluid conduit 26. The unit 100 includes a central tee 144 threaded to the conduit 26, two pipe sections 142 threaded to the tee 144, and end caps 152 threaded to the outer ends of the pipe sections 142. The tee and pipe sections form a cylindrical fluid plenum centered on an axis “W”. Drill holes 146 in the pipe sections 142 form fluid nozzles. Drill holes 146 are positioned along a line S. As can be seen in FIG. 8, the line of nozzle holes 146 is oriented toward the upstream end of fluid conduit 26 rather than straight downward toward the axis W. The preferred orientation of the holes 146 is similar to the downward orientation of the nozzle 46. In addition, drill holes (not shown) are positioned along axis W in each end cap 152 (similar to openings 52) and are in fluid communication with the pipe sections 142. Wheels, a sweep member, a cover, etc. may be used with this embodiment as in other embodiments.

In operation, the blower tool of the present invention may be used substantially immediately after a cremation process without allowing time for a cool down of the cremains. The operator places the downstream end of the device in the crematory and holds the upstream end slightly upward to allow the wheels 50 to roll along the crematory floor to the back wall without allowing the sweep member to drag along the floor. When fully extended to the back wall of the crematory, the tube 26 may be lowered such that the sweep member 60 engages the floor. As compressed fluid is provided through the fluid conduit to the fluid distribution unit, the fluid stream, preferably at an angle to the crematory floor and to the corners of the floor, dislodges cremains and moves them toward the crematory door. As the tool is pulled toward the door, the sweep member brushes the floor and loosens cremains. The blown air keeps moving the cremains toward the door, and the cover member 70 prevents excessive displacement of the cremains. The fluid distribution unit may be used to move cremains through the door opening and out to the cremains collection receptacle located immediately outside the cremation chamber.

The descriptions of specific embodiments of the invention herein are intended to be illustrative and not restrictive. The invention may be practiced otherwise than as specifically explained and illustrated without departing from its spirit or scope as defined by the appended claims.

What is claimed is:

1. A tool comprising:
a. a fluid conduit having an upstream end portion, a downstream end portion, and an axis extending between the upstream and downstream end portions,
b. a fluid distribution unit attached to the downstream end portion, the fluid distribution unit in fluid communication with the fluid conduit, the fluid distribution unit including a nozzle, the nozzle opening toward the upstream end portion at an acute angle relative to the axis.

2. The tool defined in claim 1 wherein the fluid conduit is rigid tube and the axis is central to the tube.

3. The tool defined in claim 1 further comprising a wheel rotatably attached to the fluid distribution unit.

4. The tool defined in claim 1 wherein the fluid distribution unit includes a fluid plenum, and wherein the nozzle comprises a slit in fluid communication with the plenum, the slit extending transverse to the axis.

5. The tool defined in claim 4 wherein the fluid distribution unit has a width transverse to the axis of about 6 inches, and wherein the nozzle slit extends about 6 inches.

6. The tool defined in claim 1 wherein the fluid distribution unit comprises a fluid plenum, the plenum having a fluid entrance port in fluid communication with the fluid conduit and a fluid exit port extending transverse to the axis and transverse to the nozzle opening.

7. The tool defined in claim 2 further comprising a sweep member adjacent the fluid distribution unit, the sweep member including metal bristles.

8. The tool defined in claim 7 further comprising a cover extending between the fluid distribution unit and the sweep member.

9. The tool defined in claim 1 wherein fluid conduit is in fluid communication with the fluid distribution unit through two secondary fluid conduits.

10. The tool defined in claim 9 further comprising a fluid compressor in fluid communication with the tube, the fluid compressor capable of providing fluid at 40-60 psi.

11. The tool defined in claim 10 further comprising a valve adjacent the upstream end portion to regulate fluid from the fluid compressor.

12. The tool defined in claim 1 wherein the fluid distribution unit includes a fluid plenum, and wherein the nozzle comprises a series of ports in fluid communication with the plenum, the ports positioned along a line extending transverse to the axis.

13. The tool defined in claim 1 wherein the fluid conduit is at least eight feet in length.

14. A tool comprising:
a. a rigid metal fluid conduit having an upstream end portion, a downstream end portion, and an axis extending between the upstream and downstream end portions,
b. a metal fluid distribution unit attached to the downstream end portion, the fluid distribution unit in fluid communication with the fluid conduit, the fluid distribution unit having a length extending at an oblique angle relative to the axis, fluid distribution unit including a nozzle extending generally along the length of the fluid distribution unit,
c. a metal wheel rotatably attached to the fluid distribution unit, and
d. a metal cover extending from the fluid distribution unit toward the upstream end portion.

15. The tool defined in claim 14 wherein in the nozzle opens toward the upstream end portion at an acute angle relative to the axis.

16. The tool defined in claim 14 wherein in the fluid distribution unit includes a port in fluid communication with the fluid conduit, the port opening in a direction transverse to the axis and generally parallel to the fluid distribution unit length.

17. The tool defined in claim 14 wherein in the fluid distribution unit includes a plenum in fluid communication with the fluid conduit.

18. The tool defined in claim 17 further comprising a fastener rotatably attaching the wheel to the fluid distribution unit, the wheel having an axis of rotation, the fastener extending coaxially with the wheel axis of rotation, the fastener including a port in fluid communication with the plenum.

19. A crematory tool comprising:
a. a rigid metal fluid conduit having an upstream end portion, a downstream end portion, and an fluid conduit axis extending between the upstream and downstream end portions,
b. a metal fluid distribution unit attached to the downstream end portion, the fluid distribution unit in fluid communication with the fluid conduit, the fluid distribution unit including a plenum in fluid communication with the fluid conduit, the plenum having a length, the length defining a plenum axis, the plenum axis extending at a substantially right angle relative to the fluid conduit axis, the plenum including a slit defining a nozzle, the slit extending the length of the fluid distribution unit, the slit opening toward the upstream end portion at an angle of about 70-89 degrees relative to the fluid conduit axis,
c. a metal wheel rotatably attached to the fluid distribution unit, the wheel having an axis of rotation parallel to the plenum axis,
d. a metal sweep member attached to the fluid conduit between the fluid distribution unit and the upstream end portion, and
e. a metal cover extending from the fluid distribution unit to the sweep member.

20. The crematory tool defined in claim 19 further comprising a fastener rotatably attaching the wheel to the fluid distribution unit, the wheel having an axis of rotation, the fastener extending coaxially with the wheel axis of rotation, the fastener
